(19) United States
(12) Patent Application Publication
(10) Pub. No.: US 2016/0043437 A1
(43) Pub. Date: Feb. 11, 2016

(54) PURE ELECTROLYTE

(71) Applicant: LANXESS DEUTSCHLAND GMBH, Köln (DE)

(72) Inventors: Matthias BOLL, Cologne (DE); Wolfgang EBENBECK, Leverkusen (DE); Bjoern SCHLUMMER, Bonn (DE)

(73) Assignee: LANXESS Deutschland GmbH, Cologne (DE)

(21) Appl. No.: 14/782,950

(22) PCT Filed: Apr. 10, 2014
(86) PCT No.: PCT/EP2014/057265

§ 371 Date: Oct. 7, 2015

(30) Foreign Application Priority Data
Apr. 12, 2013 (EP) 13163521.1

(51) Int. Cl. H01M 10/0568; H01M 10/052; C01D 15/00

(52) U.S. Cl. CPC H01M 10/0568; C01D 15/005; H01M 10/052; C01P 2006/40; C01P 2006/80; H01M 2300/0025

(57) ABSTRACT

The present invention relates to pure lithium hexafluorophosphate and its use in an electrolyte and also a process for reducing the content of fluoride in lithium hexafluorophosphate.

The present invention relates to pure lithium hexafluorophosphate and its use in an electrolyte and also a process for reducing the content of fluoride in lithium hexafluorophosphate.

The widespread use of portable electronic appliances, e.g. laptop and palmtop computers, mobile telephones or video cameras and thus also the demand for light high-performance batteries and rechargeable batteries has increased worldwide in recent years. This will be added to in the future by the provision of electric vehicles with such rechargeable batteries and batteries.

Lithium hexafluorophosphate (LiPF₆) has attained great industrial importance especially as electrolyte salt in the production of high-performance rechargeable batteries. Since the early 1990s, rechargeable lithium ion batteries have been commercially available.

However, lithium hexafluorophosphate is an extremely hydrolysis-sensitive compound having a low thermal stability, so that the corresponding rechargeable lithium batteries and also the salts can be produced only by means of very complicated and thus also very costly processes because of these properties. The hydrolysis products formed from lithium hexafluorophosphate, for instance hydrogen fluoride, cause, especially in the presence of water, a high corrosive action towards some components present in the rechargeable battery, for instance the anode and cathode, and therefore significantly reduce the life and the performance of rechargeable lithium ion batteries.

A further criterion for use in rechargeable lithium ion batteries is the purity, in particular the absence of metal cations. Metallic impurities get into the lithium hexafluorophosphate as a result of, for example, abrasion of metallic reactor walls during the production process. The presence of metal cations can influence the properties of electrolytes as a result of undesirable redox processes.

In order to ensure the function and life and thus the quality of such rechargeable batteries, it is therefore particularly important for the lithium compounds used to be highly pure and thus have a very low content of fluoride and metallic impurities.

Processes for preparing pure lithium hexafluorophosphate are known from the prior art.

WO 99/062821 A1 describes a process for preparing pure, free-flowing lithium hexafluorophosphate by crystallization from organic solvents, in which lithium hexafluorophosphate is crystallized from a solution in an aprotic organic solvent by adding a second inert aprotic solvent to this solution and then largely distilling off the first solvent. The content of hydrogen fluoride here is 60 ppm.

U.S. Pat. No. 5,378,445 A describes the preparation of pure lithium hexafluorophosphate by acidifying a suspension of lithium fluoride in diethyl ether and subsequently reacting it with phosphorus pentachloride. After the reaction is complete, this mixture is neutralized, filtered and either evaporated to dryness or lithium hexafluorophosphate is crystallized out by means of a crystallization aid. Lithium hexafluorophosphate etherate obtained is then dissolved in methylcyclohexane and evaporated.

A disadvantage of the prior art cited above is the fact that a distillation is necessary to obtain solid lithium hexafluorophosphate having a high freedom from solvents. This leads to high production costs. Lithium hexafluorophosphate is of particular interest as industrial raw material when it can be obtained by means of a very simple and technically controllable process. There is therefore a need for a simple-to-realize industrial process having a very small number of process steps for reducing the content of fluoride in lithium hexafluorophosphate solutions.

It was accordingly an object of the present invention to develop an efficient process for decreasing impurities in lithium hexafluorophosphate.

To achieve this object, the present invention provides a process for preparing lithium hexafluorophosphate having a low content of fluorides which comprises at least the steps
a) provision of a solution containing lithium hexafluorophosphate, fluoride and a first organic solvent containing nitride,
b) contacting with a further organic solvent which is different from the first organic solvent, resulting in lithium hexafluorophosphate precipitating, and c) isolation of the precipitated lithium hexafluorophosphate.

It may be remarked at this point that the scope of the invention encompasses all desired and possible combinations of the components, value ranges and process parameters mentioned above and in the following, in general or in preferred ranges.

The solutions containing lithium hexafluorophosphate, fluoride and a first organic solvent which are provided in step a) typically have a content of lithium hexafluorophosphate of from 0.1 to 50.0% by weight, preferably from 1.0 to 45.0% by weight, particularly preferably from 5.0 to 40.0% by weight, as a result of which they can, in particulars be processed further to give electrolytes suitable for electrochemical storage devices.

Possible ways of preparing the lithium hexafluorophosphate used in the solutions in step a) are known to those skilled in the art. For example, lithium hexafluorophosphate can be prepared by reaction of phosphorus pentafluoride and lithium fluoride in diethyl ether. Phosphorus pentafluoride can in turn be obtained, for example, by reaction of calcium fluoride with phosphorus pentachloride.

The solutions containing lithium hexafluorophosphate, fluoride and a first organic solvent which are provided in step a) can be provided in alternative ways, for example by:

Variant a: Derivation of lithium hexafluorophosphate and fluoride in a first organic solvent from a production process

Variant b: Addition of solid, fluoride-containing lithium hexafluorophosphate to a first organic solvent

Variant c: Addition of a first organic solvent to solid, fluoride-containing Variant d: Provision of, for example, commercially available electrolytes.

Variant e: Dissolution of solid lithium hexafluorophosphate in water-containing first organic solvent

In the abovementioned forms of provision, the fluoride typically originates from the production process and from the hydrolytic decomposition of the lithium hexafluorophosphate by traces of adhering water.

The solutions containing lithium hexafluorophosphate, fluoride and a first organic solvent which are provided in step a) typically have a content of fluoride of from 500 to 10 000 ppm, preferably from 800 to 6000 ppm. For the purposes of the present invention, content of fluoride is that amount of fluoride which can be determined by ion chromatography as total of dissolved fluorides and hydrogen fluoride. The detailed procedure for carrying out the method is described in the examples of the present invention.

The ppm figures indicated here relate generally, unless explicitly indicated otherwise, to proportions by weight, and the contents of the specified cations and anions are determined by ion chromatography as described in the experimental part, unless indicated otherwise.

The first organic solvent contains at least one nitrile. Here, it is possible to use, for example, one nitrile, a combination of various nitriles or a combination of at least one nitrile with at least one organic solvent which is not a nitrile.

Examples of suitable nitriles are acetonitrile, propanenitrile and benzonitrile. Particular preference is given to using acetonitrile, with greater preference being given to using acetonitrile without an organic solvent which is not a nitrile as first organic solvent.

For example, the molar ratio of nitriles used to the respective amount of lithium ions in the solutions provided in step a) is at least 1:1, preferably at least 10:1 and particularly preferably at least 50:1 and very particularly preferably at least 100:1.

If a first organic solvent contains organic solvents which are not a nitrile, preference is given to using such organic solvents which are liquid at room temperature and have a boiling point of 300° C. or less at 1013 hPa and also contain at least one oxygen atom or a nitrogen atom or both.

Preferred organic solvents are ones which do not have any protons and have a pKa at 25° C. relative to water or an aqueous comparative system of less than 20. Such organic solvents are also referred to as “aprotic” solvents in the literature.

Examples of such further solvents are esters, organic carbonates, ketones, ethers, acid amides or sulfones which are liquid at room temperature.

Examples of ethers are diethyl ether, diisopropyl ether, methyl tert-butyl ether, ethylene glycol dimethyl and diethyl ether, 1,3-propanediol dimethyl and diethyl ether, dioxane and tetrahydrofuran.

Examples of esters are methyl and ethyl acetate and butyl acetate or organic carbonates such as dimethyl carbonate (DMC), diethyl carbonate (DEC) or propylene carbonate (PC) or ethylene carbonate (EC).

An example of a sulfone is sulfolane.

Examples of ketones are acetone, methyl ethyl ketone and acetophenone.

Examples of acid amides are N,N-dimethylformamide, N,N-dimethylacetamide, N-methylformanilide, N-methylpyrrolidone or hexamethylphosphoramide.

The first organic solvent according to the invention can also contain a plurality of the organic solvents mentioned.

The further organic solvent according to the invention is characterized in that lithium hexafluorophosphate has a lower solubility in the further organic solvent than in the first organic solvent.

It will be clear to a person skilled in the art that the dissolution behavior depends on the temperature, and for this reason the abovementioned requirement for the temperature selected in step b) has to be satisfied.

The temperature during contacting can, by way of example and preferably, be effected in the range from the freezing point to the boiling point of the organic solvent used or the lowest-boiling component thereof, for example from −45 to 80° C., particularly from 10 to 60° C. and particularly preferably from 10 to 35° C., in particular from 16 to 24° C.

The pressure during contacting can, for example, be from 100 hPa to 2 MPa, preferably from 900 hPa to 1200 hPa, with ambient pressure being particularly preferred.

The contacting as per step b) is preferably carried out over a period of from one second to 48 hours, preferably from 10 seconds to 2 hours, particularly preferably from 30 seconds to 45 minutes and very particularly preferably from 1 minute to 30 minutes.

In an alternative embodiment, the contacting as per step b) can be followed by mixing in order to introduce mixing energy, e.g. by means of static or nonstatic mixing elements.

As further organic solvent, preference is given to toluene.

The solubility of lithium hexafluorophosphate in the first organic solvent and in the further organic solvent as such can be determined by means of a few preliminary tests.

The first organic solvent according to the invention and the further organic solvent are preferably subjected to a drying process, particularly preferably a drying process over a molecular sieve, before use.

The content of impurities, in particular water, in the first organic solvent according to the invention and the further organic solvent should be very low. In one embodiment, it is from 0 to 500 ppm, preferably from 0 to 200 ppm, particularly preferably from 0 to 100 ppm and very particularly preferably 1 ppm or less.

The contacting can, for example, be carried out by adding further organic solvent to initially charged solutions containing lithium hexafluorophosphate, fluoride and a first organic solvent which have been provided in step a).

Contacting can preferably be carried out by adding the solution provided in step a) to the further organic solvent.

Any other order of contacting lithium hexafluorophosphate, fluoride, a first organic solvent and a further organic solvent is likewise suitable for carrying out the process of the invention.

The contacting of the solution containing lithium hexafluorophosphate, fluoride and a first organic solvent with further organic solvent can, for example, be carried out continuously, for example by introducing the further organic solvent, or batchwise, for example by addition in portions, preferably by dropwise addition, of further organic solvent. Any vessel known to those skilled in the art for contacting solutions is suitable for the contacting operation. Contacting can be assisted by introduction of mixing energy, for example by means of static or nonstatic mixing elements.

The contacting as per step b) precipitation of lithium hexafluorophosphate.

In a further embodiment, further contacting with further organic solvent or other organic solvents can be carried out after step b). This has the purpose of allowing a further solvent exchange to be carried out in addition to drying.

The isolation of the precipitated lithium hexafluorophosphate can be carried out by any method known to those skilled in the art for separating solids and liquids. For example, isolation can be effected by sedimentation, centrifugation or filtration, for example by pressure filtration or suction filtration. Isolation can, for example, be carried out using a paper filter, polymer filter, a glass frit or a ceramic frit, in particular by means of a filter having a defined pore size, for example a filter having a pore size of <5 μm, preferably <1 μm, particularly preferably <200 nm.

In an alternative embodiment, isolation as per step c) can be followed by, as further process step

d) at least one washing step with organic solvent, preferably further organic solvent.

The process of the invention reduces the content of fluoride in solutions containing lithium hexafluorophosphate, fluoride and a first organic solvent.

In a preferred embodiment, the content of fluoride in lithium hexafluorophosphate is, proceeding from solutions containing lithium hexafluorophosphate, fluoride and a first organic solvent, reduced by 50%, preferably 95% or more and very particularly preferably by 98% or more, by means of the process of the invention, where the reduction in each case relates to fluoride content based on dry matter of lithium hexafluorophosphate.

In a further embodiment, the content of fluoride in the solid lithium hexafluorophosphate obtained according to the invention is, for example, less than 300 ppm, preferably less than 100 ppm, particularly preferably leas than 50 ppm.

The solutions containing lithium hexafluorophosphate, fluoride and a first organic solvent which are provided in step a) can, in an alternative embodiment, contain impurities. Typical impurities are chloride, hydrolytic decomposition products, in particular lithium difluorophosphate, acids and also metal cations, in particular calcium, chromium, iron, magnesium, molybdenum, cobalt, nickel, cadmium, lead, potassium or sodium, and foreign anions, in particular sulfate, hydroxide, hydrogencarbonate and carbonate.

For the purposes of the present invention, an acid is any component which contributes to the total acid content, in particular hydrogen fluoride. The total acid content is determined as indicated in the examples. Substances which make a contribution to the total acid content are substances which, in aqueous or nonaqueous systems, can change the color of a solution of bromothymol blue (pKa 7.10) from bluish green to yellow. Such substances typically include the acidic hydrolysis products of lithium hexafluorophosphate, in particular hydrogen fluoride.

The solutions containing lithium hexafluorophosphate, fluoride and a first organic solvent which are provided in step a) typically have a metal content, in particular calcium, chromium, iron, magnesium, molybdenum, cobalt, nickel, cadmium, lead, potassium and sodium, of from 1 to 2000 ppm, preferably from 1 to 100 ppm and particularly preferably from 1 to 50 ppm.

In a further embodiment, the chromium content in lithium hexafluorophosphate is, proceeding from solutions containing lithium hexafluorophosphate, fluoride and a first organic solvent, reduced to 7 ppm or less by the process of the invention, where the reduction in each case relates to chromium content based on dry matter of lithium hexafluorophosphate.

In a further embodiment, the iron content in lithium hexafluorophosphate is, proceeding from solutions containing lithium hexafluorophosphate, fluoride and a first organic solvent, reduced by 60% or more by means of the process of the invention, where the reduction in each case relates to iron content based on dry matter of lithium hexafluorophosphate.

In a further embodiment, the nickel content in lithium hexafluorophosphate is, proceeding from solutions containing lithium hexafluorophosphate, fluoride and a first organic solvent, reduced to 3 ppm or less by the process of the invention, where the reduction in each case relates to nickel content based on dry matter of lithium hexafluorophosphate.

The invention further provides for the use of the lithium hexafluorophosphate which has been purified according to the invention as or for producing electrolytes for rechargeable lithium batteries.

Electrolytes can be produced according to methods which are generally known per se by contacting lithium hexafluorophosphate with organic solvent and optionally additives. The invention therefore further provides a process for producing electrolytes for rechargeable lithium batteries, characterized in that the lithium hexafluorophosphate used comprises by a process comprising at least the steps a) to c) of the process of the invention.

The electrolytes produced by the process of the invention can contain further electrolyte salts such as lithium fluorosulfonylimide.

The advantage of the invention is, in particular, the efficient and rapid method of operation, the high purity which can be achieved and the reduced content of fluoride and metals in the lithium hexafluorophosphate prepared according to the invention.

### EXAMPLES

In the following, “%” is always % by weight and “ppm” is always “ppm by weight”.

“Under inert gas conditions” or inert gas means that the water content and the oxygen content of the atmosphere is below 1 ppm.

Determination of the Water Content:

The water content was, unless indicated otherwise, determined by the Karl-Fischer method, which is known to those skilled in the art and is described, for example, in “Wasserbestimmung durch Karl-Fischer-Titration” by G. Wieland, GIT-Verlag Darmstadt, 1985, by Coulombometric titration using a titrtor (851 KF Titrando from Metrohm).

With regard to the determination of the total acid content employed for the purposes of the present work, reference may be made to the publication M. Schmidt, U. Heider, A. Kuehner, R. Oesten, M. Jungnitz, N. Ignat'ev, P. Sartori, Lithium fluoroalkylphosphates; a new class of conducting salts for electrolytes for high energy lithium-ion batteries. Journal of Power Sources 97-98 (2001) 557-560, and also the references cited therein. To determine the total acid content, 1.79 g of the electrolyte solid were dissolved in 13.21 g of a mixture of ethylene carbonate and dimethyl carbonate (weight ratio 1:1) while cooling. Part of the solution was titrated as described in the above-cited reference to determine the total acid content. In a glass vessel, 0.2 ml of indicator solution (50 mg of bromothymol blue in 50 ml of water-free isopropanol) was titrated under inert conditions with a 0.01 N tetrabutylammonium hydroxide solution (in water-free isopropanol) until a color change to bluish green occurred. Subsequently, about 1000 mg of electrolyte solution were weighed out to within 0.1 mg. Titration with 0.01 N tetrabutylammonium hydroxide solution was once again carried out to a color change to bluish green, and the consumption of tetrabutylammonium hydroxide solution was weighed to within 0.1 mg.

With regard to the ion chromatography used for the purposes of the present work, reference may be made to the publication L. Terborg, S. Nowak, S. Passerini, M. Winter, U. Karst, P. R. Haddad, P. N. Nesterenko, Ion chromatographic determination of hydrolysis products of hexafluorophosphate salts in aqueous solution. Analytica Chimica Acta 714 (2012) 121-126, and the references cited therein.

The analysis to determine the ions present (calcium, fluoride, hexafluorophosphate) was carried out by ion chromatography. For this purpose, the following instruments and settings were used:
Instrument type: Dionex ICS 2100
Column: IonPac AS20 2*250 -mm analytical column with protective device
Sample volume: 1 μl
Eluent: KOH gradient: 0 min/15 mM, 10 min/15 mM, 13 min/80 mM, 27 min/100 mM, 27.1 min/15 mM, 34 min/15 mM
Eluent flow rate: 0.25 ml/min
Temperature: 30° C.
SRS: ASRS 300 (2-mm)

The determination of the chromium content was carried out by means of optical emission spectroscopy with inductively coupled plasma (ICP-OES, instruments Varian Vista Pro).

Other metal contents were determined by means of a quick photometric test from Merck (Spectroquant® cell test). A Spectroquant Pharo 100 M (Merck) was used as photometer.

### Example 1

(According to the Invention):

50 g of a filtered solution (200 nm Teflon filter) containing 21.8% by weight of lithium hexafluorophosphate and 839 ppm of fluoride in acetonitrile (i.e. 3848 ppm based on dry matter of solid lithium hexafluorophosphate) were added over a period of 10 minutes to 50 ml of toluene (6.4 ppm water content) while stirring. Lithium hexafluorophosphate precipitated. The suspension was then stirred for a further 30 minutes. The suspension was filtered through a Teflon nonwoven having a mesh opening of 5 μm under inert gas conditions and the residue was washed on the filter with 50 g of toluene (6.4 ppm water content). The residue was dried in a stream of argon (600 l/h) at room temperature for 2 hours. This gave 3.0 g of a white powder which was analyzed by ion chromatography. The content of lithium hexafluorophosphate was 90.6% by weight and the content of fluoride was now only 39 ppm (based on the dry mass). The remainder to make up 100% by weight was residual solvent. The reduction in the content of fluoride was 98%.

### Example 2

(According to the Invention): Alternative Order of Addition

50 g of a solution containing 16.7% by weight of lithium hexafluorophosphate and 5800 ppm of fluoride in acetonitrile (i.e. 34 730 ppm based on dry matter of solid lithium hexafluorophosphate) were filtered through a Teflon filter having a pore width of 200 nm.

200 g of toluene (15.2 ppm water content) were then added to the solution over a period of 30 minutes while stirring.

Lithium hexafluorophosphate precipitated. The suspension was then stirred for a further 30 minutes. The suspension was filtered via a pressure filter. The residue was then washed once with 50 g of toluene. The residue was dried in a stream of argon (600 l/h) at room temperature for 2 hours. This gave 6.7 g of a white powder which was analyzed by ion chromatography. The content of lithium hexafluorophosphate was 92.2% by weight and the content of fluoride was now only 99 ppm (based on the dry mass). The reduction in the content of fluoride was 99%.

### Example 3

(According to the Invention):

50 g of a filtered solution (200 nm Teflon filter) containing 16.7% by weight of lithium hexafluorophosphate and 5800 ppm of fluoride in acetonitrile (i.e. 34 730 ppm based on dry matter of solid lithium hexafluorophosphate) were added over a period of 30 minutes to 200 g of toluene (15,2 ppm water content) while stirring.

Lithium hexafluorophosphate precipitated. The suspension was stirred for a further 30 minutes. The suspension was filtered via a pressure filter. The residue was then washed once with 50 g of toluene. The residue was dried in a stream of argon (600 l/h) at room temperature for 2 hours. This gave 7.4 g of a white powder which was analyzed by ion chromatography. The content of lithium hexafluorophosphate was 95.0% by weight and the content of fluoride was now only 282 ppm (based on the dry mass). The reduction in the content of fluoride was 99%.

### Example 4

(Comparative Experiment): Alternative Order of Addition (Cyclohexane)

50 g of a solution containing 18.8% by weight of lithium hexafluorophosphate in acetonitrile were filtered through a 200 nm Teflon filter.

This solution was then added to 200 g of cyclohexane (2.3 ppm water content) over a period of 30 minutes while stirring.

This gave a two-phase system without precipitation of solid.

### Example 5

(According to the Invention): Depletion of Heavy Metals

50 g of a solution containing 16.7% by weight of lithium hexafluorophosphate, 5800 ppm of fluoride (i.e. 34 730 ppm based on dry matter of solid lithium hexafluorophosphate) and metal impurities (see table 1) in acetonitrile were filtered through a 200 nm Teflon filter.

200 g of toluene (15.2 ppm of water) were then added to this solution over a period of one minute while stirring.

Lithium hexafluorophosphate precipitated. The suspension was stirred for a further 30 minutes. The suspension was filtered through a pressure filter. The residue was then washed once with 50 g of toluene. The residue was dried in a stream of argon (600 l/h) at room temperature for 2 hours. This gave 8.0 g of a white powder which was analyzed by ion chromatography. The content of lithium hexafluorophosphate was 86.0% by weight and the content of fluoride was now only 226 ppm (based on the dry mass). The reduction in the content of fluoride was 99%.

Based on the lithium hexafluorophosphate used, the following metals were present (figures in ppm before and after crystallization):

TABLE 1
Metal content before and after precipitation

| Metal | LiPF₆ used [ppm] | Purified LiPF₆ [ppm] |
|---|---|---|
| Ca | 3 | 2 |
| Cr | 8 | <1 |
| Fe | 17 | 2 |
| Ni | 3 | 2 |

### Example 6

(According to the Invention): Washing of Lithium Hexafluorophosphate with Acetonitrile/toluene

37.5 g of acetonitrile were introduced into a suspension of 30 g of lithium hexafluorophosphate (475 ppm total acid) in 150 g of toluene at −10° C. and the mixture was stirred for another 2 hours. The mixture was subsequently filtered through a 200 nm Teflon filter.

The filtercake was washed with 50 g of acetonitrile/toluene (weight ratio 1:4). This procedure was repeated three times. The filtercake was subsequently blown dry in a stream of argon (600 l/h). This gave a white powder which was analyzed by ion chromatography. The total acid content was now only 15 ppm (based on the dry mass).

| Metal | LiPF₆ used [ppm] | Purified LiPF₆ [ppm] |
|---|---|---|
| Ca | 4.8 | 2 |
| Cr | 18 | 7 |
| Fe | 61 | 22 |
| Ni | 12 | 3 |

1. A process for preparing crystallized lithium hexafluorophosphate having a low content of fluoride, the process comprising:
contacting a solution containing lithium hexafluorophosphate, fluoride and a first organic solvent containing nitrite, with a further organic solvent which is different from the first organic solvent, to crystallize lithium hexafluorophosphate, and
isolating the crystallized lithium hexafluorophosphate.

2. The process as claimed in claim 1, wherein the solution has a content of lithium hexafluorophosphate of 0.1 to 50.0% by weight.

3. The process as claimed in claim 1, wherein the solution has a content of fluoride of from 500 to 10,000 ppm.

4. The process as claimed in claim 1, wherein the first organic solvent comprises a nitrile, a combination of nitriles or a combination of at least one nitrile with at least one solvent which is not a nitrile.

5. The process as claimed in claim 1, wherein the lithium hexafluorophosphate has a solubility in each of the first organic solvent and the further organic solvent, and the process comprises selecting the further organic solvent such that the lithium hexafluorophosphate has a lower solubility in the further organic solvent than in the first organic solvent.

6. The process as claimed in claim 1, wherein the first organic solvent and the further organic solvent each have an impurity content of 0 to 500 ppm.

7. The process as claimed in claim 1, wherein the crystallized lithium hexafluorophosphate has a content of fluoride that is at least about 50% less than the content of fluoride in the solution, where the reduction relates to fluoride content based on the dry matter of lithium hexafluorophosphate.

8. The process as claimed in claim 1, wherein the solution contains impurities.

9. The process as claimed in claim 1, wherein the solution has a metal content of to 2000 ppm.

10. The process as claimed in claim 1, wherein the crystallized lithium hexafluorophosphate has a chromium content of 7 ppm or less based on dry matter of lithium hexafluorophosphate.

11. The process as claimed in claim 1, wherein the crystallized lithium hexafluorophosphate has an iron content at least about 60% less than an amount of iron in the solution where the reduction relates to iron content based on dry matter of lithium hexafluorophosphate.

12. The process as claimed in claim 1, wherein the crystallized lithium hexafluorophosphate has a nickel content of 3 ppm or less, based on dry matter of lithium hexafluorophosphate.

13. (canceled)

14. A process for producing electrolytes for rechargeable lithium batteries, the process comprising:
contacting a solution containing lithium hexafluorophosphate, fluoride, and a first organic solvent containing nitrile, with a further organic solvent to crystallize lithium hexafluorophosphate, wherein the lithium hexafluorophosphate has a lower solubility in the further organic solvent than in the first organic solvent;
isolating the crystallized lithium hexafluorophosphate; and
re-dissolving the crystallized lithium hexafluorophosphate in an additional solvent to produce electrolytes.

15. An electrolyte for rechargeable lithium batteries, wherein the electrolyte is produced by the process of claim 14.

18. The process as claimed in claim 1, wherein the first organic solvent is acetonitrile, and the further organic solvent is toluene.

17. The process as claimed in claim 1, wherein:
the solution has a lithium hexafluorophosphate content of 1.0 to 45.0% by weight, and a fluoride content of 500 to 10,000 ppm;
the first organic solvent is a nitrile, a combination of nitrites or a combination of at least one nitrile with at least one solvent which is not a nitrile;
the lithium hexafluorophosphate has a lower solubility in the further organic solvent than in the first organic solvent;
the first organic solvent and the further organic solvent each have an impurity content of 0 to 200 ppm, wherein the impurities include at least one of chloride, hydrolytic decomposition products, acids, metal cations, and foreign anions;
the crystallized lithium hexafluorophosphate has a content of fluoride that is at least about 95% less than an amount of fluoride in the solution, and an iron content that is at least about 60% less than an amount of iron in the solution, where the reduction relates to fluoride content and iron content based on the dry matter of lithium hexafluorophosphate;
the solution has a metal content of 1 to 100 ppm, wherein metals in the metal content include at least one of calcium, chromium, iron, magnesium, molybdenum, cobalt, nickel, cadmium, lead, potassium and sodium; and
the crystallized lithium hexafluorophosphate has a chromium content of 7 ppm or less and a nickel content of 3 ppm or less.

18. The process as claimed in claim 17, wherein:
the solution has a lithium hexafluorophosphate content of 5.0 to 40.0% by weight, and a fluoride content of 800 to 6000 ppm;
the first organic solvent and the further organic solvent each have an impurity content of 1 ppm or less;
the crystallized lithium hexafluorophosphate has a content of fluoride that is at least about 98% less than the content of fluoride in the solution containing lithium hexafluorophosphate, fluoride and a first organic solvent; and
the solution has a metal content of 1 to 50 ppm.

19. The process as claimed in claim 19, wherein:
the solution has a molar ratio of nitrites to lithium ions of 1:1 to 100:1;
the contacting is done at a temperature of 10° C. to 35° C. at a pressure of 900 hPa to 1200 hPa, and for a period of time of 30 seconds to 45 minutes;

20. The process as claimed in claim 20, wherein:
molar ratio of nitrites to lithium ions is 100:1
the temperature is 16° C. to 24° C., the pressure is ambient pressure, and the period of time is 1 minute to 30 minutes; and
the process further comprises:
mixing during the contacting, and
washing the crystallized lithium hexafluorophosphate after isolating.
